(19) United States
(12) Patent Application Publication
(10) Pub. No.: US 2015/0165712 A1
(43) Pub. Date: Jun. 18, 2015

(54) BOX ASSEMBLY SYSTEM AND METHOD

(71) Applicant: Mark Carey, Upper Sandusky, OH (US)

(72) Inventor: Mark Carey, Upper Sandusky, OH (US)

(21) Appl. No.: 14/571,920

(22) Filed: Dec. 16, 2014

Related U.S. Application Data
(60) Provisional application No. 61/916,567, filed on Dec. 16, 2013.

(51) Int. Cl. B31B 7/26; B65D 5/44; B65B 67/02; B65B 5/02; B65B 7/28

(52) U.S. Cl. CPC B31B 7/26; B65B 5/024; B65B 7/28; B65B 67/02; B65D 5/445

(57) ABSTRACT

A packaging system is provided that includes a first or top part that includes multiple scored segments that form multiple panels and a second part that includes multiple scored segments that form multiple panels whereby the second part is adapted to cover the first part. The first part is foldable along the multiple scored segments. Similarly, the second part is foldable along the multiple scored segments.

### CROSS-REFERENCE TO RELATED APPLICATIONS

This application claims the benefit of U.S. Provisional Patent application Ser. No. 61/916,567 entitled “BOX ASSEMBLY SYSTEM AND METHOD” filed on Dec. 16, 2013. The entirety of the above-noted application is incorporated by reference herein.

### ORIGIN

The innovation disclosed herein relates to packaging and more specifically, to a system and method to assemble a packaging container.

### BACKGROUND

Typically, packaging systems or containers are required to be assembled prior to packing a package in the container. This extra step of preassembling the container adds to the overall manufacturing and shipping costs of the package. In addition, pre-assembling containers for future packing needs requires storage space, which also adds to the overall cost. Further, pre-assembling containers may render them un-stackable thereby requiring more space and time to maintain the assemble containers.

### SUMMARY

The following presents a simplified summary in order to provide a basic understanding of some aspects of the innovation. This summary is not an extensive overview of the innovation. It is not intended to identify key/critical elements or to delineate the scope of the innovation. Its sole purpose is to present some concepts of the innovation in a simplified form as a prelude to the more detailed description that is presented later.

In one aspect, the innovation is a packaging system and method that allows a packaging carton to be assembled as the object is packed inside the packaging carton.

In another aspect of the innovation, a packaging system includes a first part having a plurality of scored segments and a plurality of panels formed by the plurality of scored segments and a second part having a plurality of scored segments and a plurality of panels formed by the plurality of scored segments, the second part being adapted to cover the first part, wherein the first part is foldable along the plurality of scored segments, and wherein the second part is foldable along the plurality of scored segments.

In another aspect of the innovation, a method of assembling a packaging container includes providing a first part and a second part, wherein the first part and the second part include a plurality of scored segments and a plurality of panels formed by the plurality of scored segments, placing the first part onto an assembly assist fixture, placing an object on the first part such that the object does not exceed a boundary of a first panel defined by the plurality of scored segments, pushing the object downward such that side rails on the assembly assist fixture force the plurality of panels on the first part upward thereby surrounding the first panel, placing edge stiffeners on opposite edges of the first part, removing the first part from the assembly assist fixture, and placing the second part over the first part thereby enclosing the object inside the first part and the second part.

In still another aspect of the innovation, a container is disclosed that includes a first part including a first set of scored segments, a second set of scored segments substantially perpendicular to the first set of scored segments, a third set of scored segments disposed at an angle with respect to the first set of scored segments and the second set of scored segments, and a plurality of panels formed by boundaries of the first set, the second set, and the third set of scored segments, wherein the first part is foldable along the first set, the second set, and the third set of scored segments.

In yet still another aspect of the innovation, a method of assembling a packaging container is disclosed that includes providing a first part and a second part, wherein the first part and the second part include a plurality of scored segments and a plurality of panels formed by the plurality of scored segments, placing the first part onto an assembly assist fixture, placing an object on the first part such that the object does not exceed a boundary of a first panel defined by the plurality of scored segments, pushing the object downward such that side rails on the assembly assist fixture force the plurality of panels on the first part upward thereby surrounding the first panel, removing the first part from the assembly assist fixture, and placing the second part over the first part thereby enclosing the object inside the first part and the second part.

To accomplish the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 is a top view of an example packaging system in accordance with an aspect of the innovation.

FIGS. 2A and 2B are top views of a first part and a second part of the packaging system in accordance with an aspect of the innovation.

FIG. 2C illustrates the assembly of the first and second part in accordance with an aspect of the innovation.

FIGS. 3A-3D are illustrations showing a packaging container that includes a stiffener at various stages of assembly in accordance with an aspect of the innovation.

FIG. 4 is an example embodiment of a support system in accordance with an aspect of the innovation.

FIGS. 5A-5D are illustrations of an assembly assist fixture in accordance with an aspect of the innovation.

FIG. 6 is a flow chart illustrating a method of assembling a packaging container in accordance with an aspect of the innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

While specific characteristics are described herein (e.g., thickness), it is to be understood that the features, functions and benefits of the innovation can employ characteristics that vary from those described herein. These alternatives are to be included within the scope of the innovation and claims appended hereto.

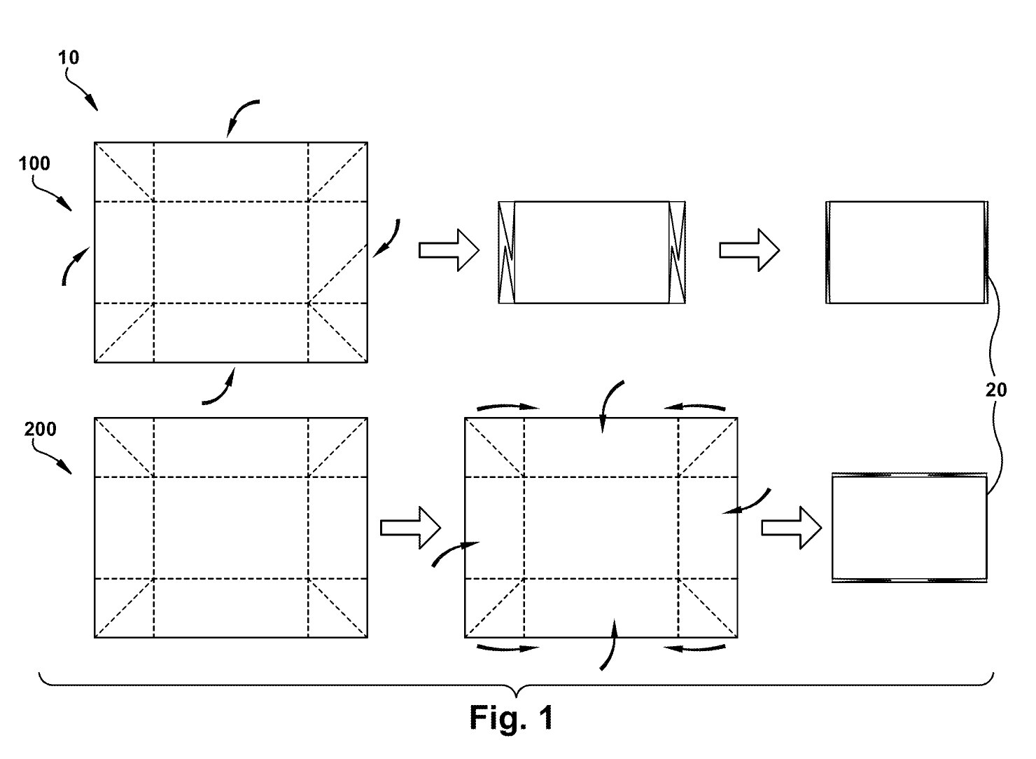

Referring now to the drawings, FIG. 1 is a top view of a packaging system 10 that facilitates the assembly of a packaging container 20 (e.g., cardboard box, carton, plastic container, etc.) in accordance with an aspect of the innovation. The packaging system 10 includes a first (bottom) part 100 adapted to receive an object and a second part 200 that functions as a cover. The second part 200 is adapted to be placed over (or inside) the first part 100. The packaging system 10 facilitates the packaging of an object inside the first and second part 100, 200 while simultaneously assembling and mating the first and second part 100, 200. Other advantages of the packaging system 10 are mentioned further below.

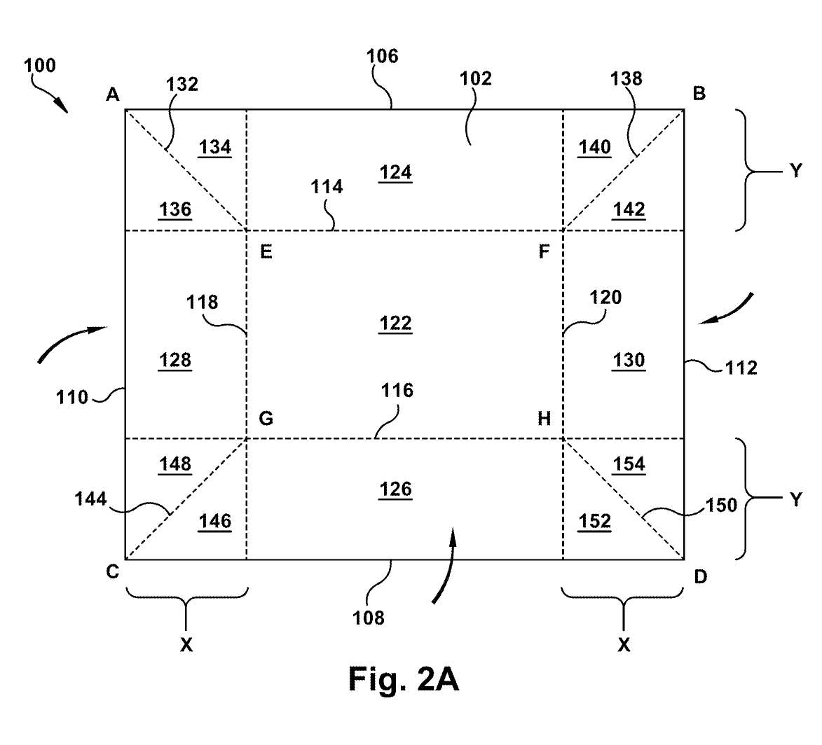

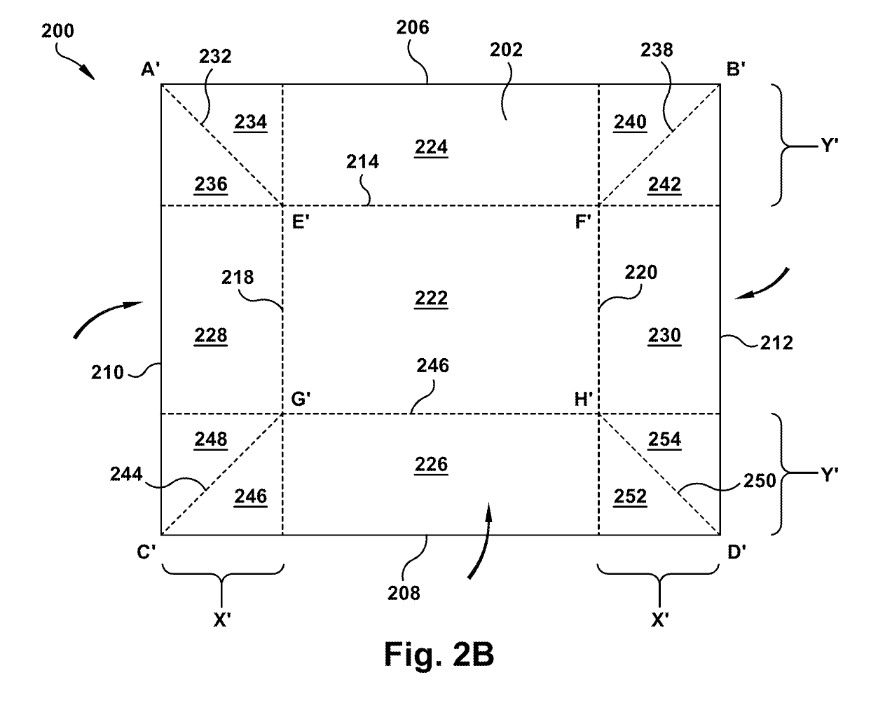

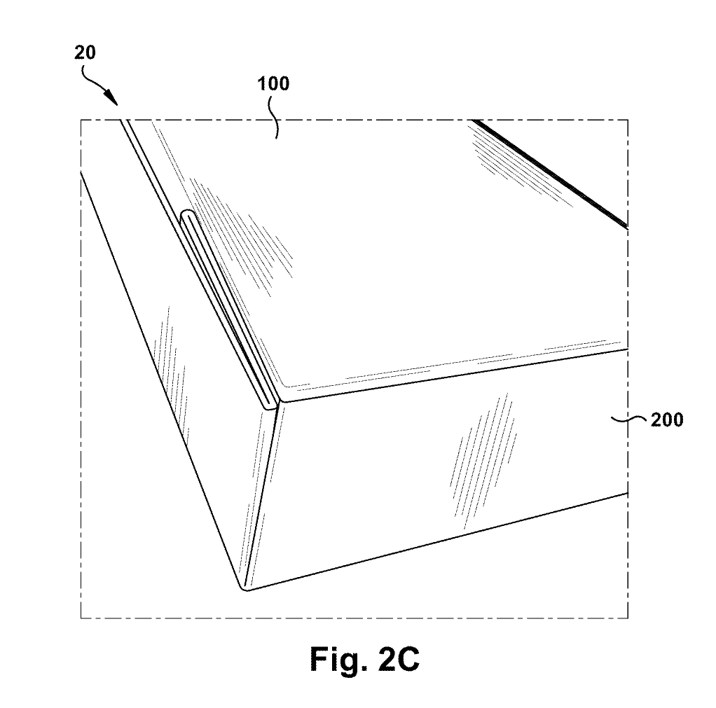

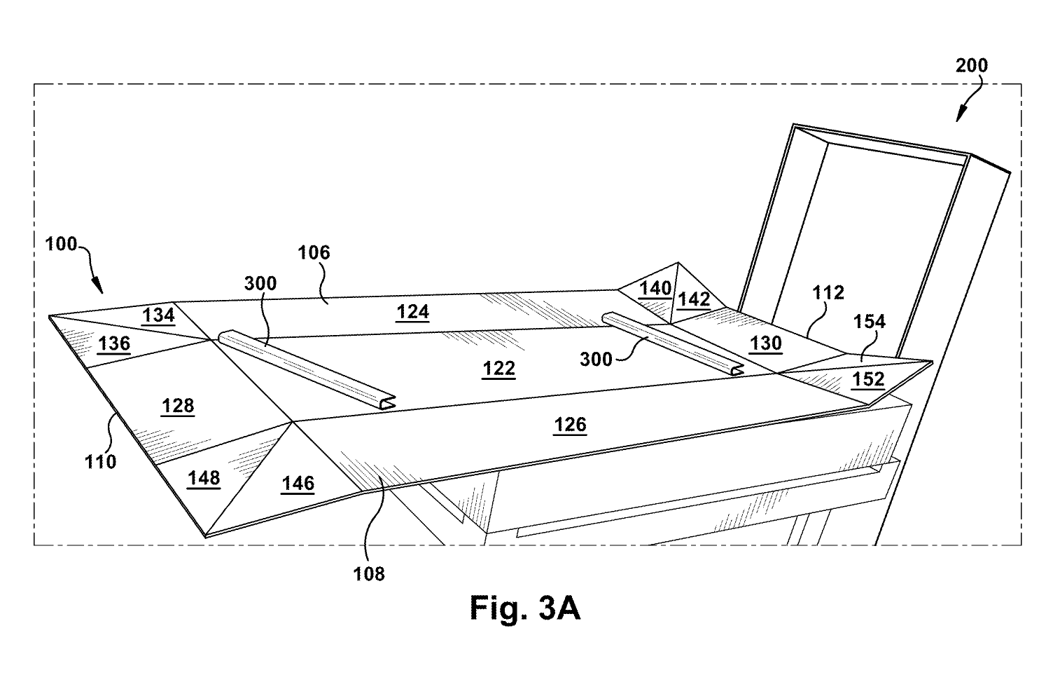

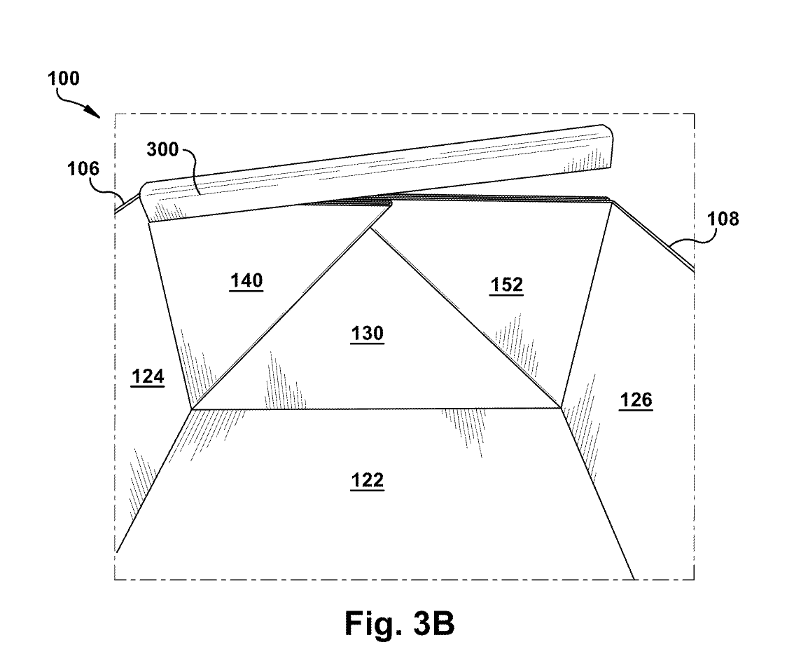

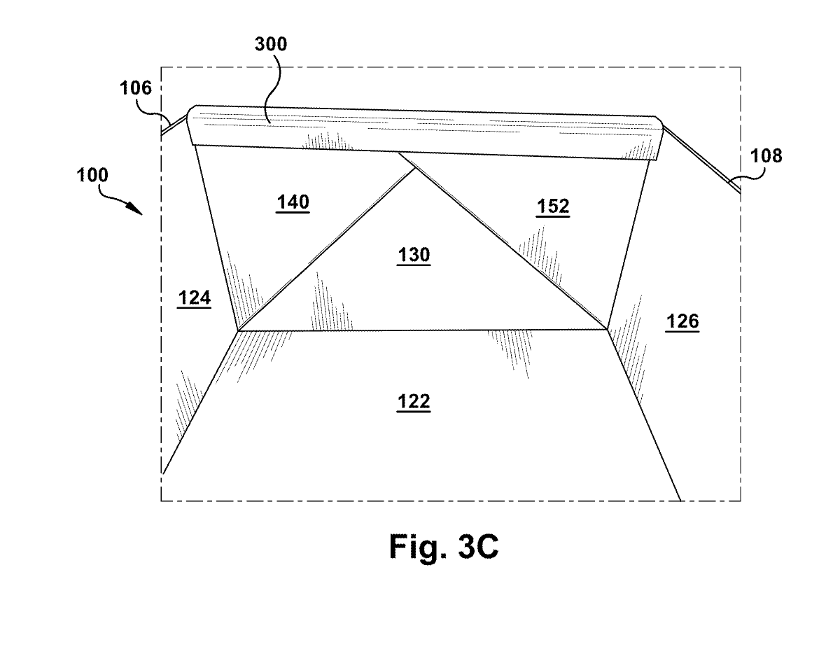

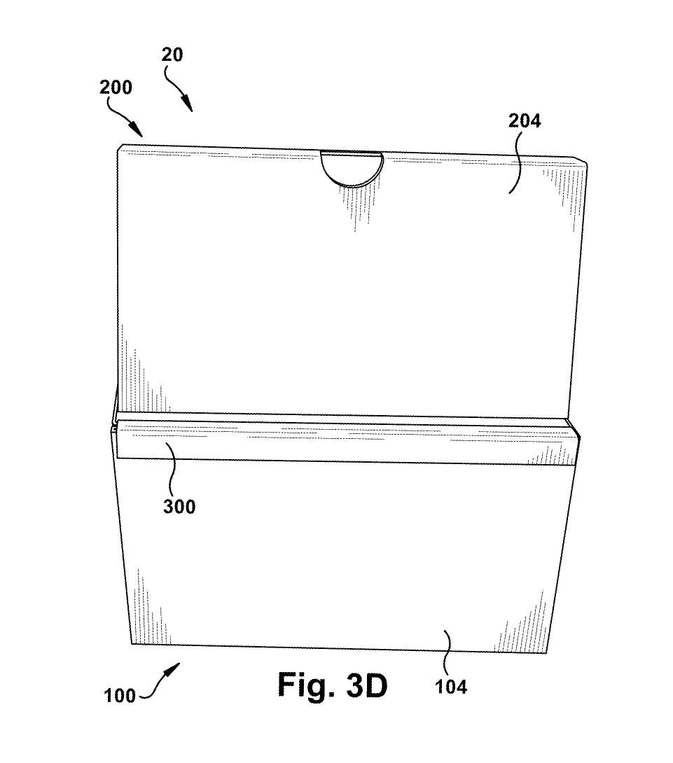

Referring to FIGS. 2A and 2B, the first part 100 includes a first (inside) surface 102, a second (outside) surface 104 (see FIG. 3D), and a plurality of edges comprised of a first edge 106, a second edge 108, a third edge 110, and a fourth edge 112. The first edge 106 and the second edge 108 are substantially parallel to each other. Similarly, the third edge 110 and the fourth edge 112 are substantially parallel to each other. In addition, the first and second edges 106, 108 are substantially perpendicular to the third and fourth edges 110, 112. The first edge 106 meets the third edge 110 at a point A and meets the fourth edge 112 at a point B. Similarly, the second edge 108 meets the third edge 110 at a point C and meets the fourth edge 112 at a point D.

The first part 100 further includes a plurality of scored segments including a first set of scored segments comprised of a first scored segment 114 and a second scored segment 116 and a second set of scored segments comprised of a third scored segment 118 and a fourth scored segment 120. The first set of scored segments 114, 116 are substantially perpendicular with the second set of scored segments 118, 120.

The first segment 114 is disposed a distance Y from the first edge 106, extends from the third edge 110 to the fourth edge 112 and is substantially parallel to the first and second edges 106, 108. The second segment 116 is disposed approximately the same distance Y from the second edge 108, extends from the third edge 110 to the fourth edge 112 and is also substantially parallel to the first and second edges 106, 108. Thus, both the first and second segments 114, 116 are substantially parallel to each other.

The third segment 118 is disposed a distance X from the third edge 110, extends from the first edge 106 to the second edge 108, and is substantially parallel to the third and fourth edges 110, 112. The fourth segment 120 is disposed approximately the same distance X from the fourth edge 112, extends from the first edge 106 to the second edge 108, and is also substantially parallel to the third and fourth edges 110, 112. Thus, both the third and fourth segments 118, 120 are substantially parallel to each other.

The first segment 114 intersects the third segment 118 at a point E and intersects the fourth segment 120 at a point F. Similarly, the second segment 116 intersects the third segment 118 at a point G and intersects the fourth segment 120 at a point H. Thus, a plurality of rectangular panels are defined by the intersection of the plurality of segments and the intersection of the plurality of segments with the plurality of edges.

Specifically, a first panel 122 is formed at a center of the first part 100 and is bound by the first, second, third and fourth segments 114, 116, 118, 120. A second panel 124 is bound by the first edge 106 and the first, third, and fourth segments 114, 118, 120. A third panel 126 is bound by the second edge 108 and the second, third, and fourth segments 116, 118, 120. A fourth panel 128 is bound by the third edge 110 and the first, second, and third segments 114, 116, 118. A fifth panel 130 is bound by the fourth edge 112 and the first, second, and fourth segments 114, 116, 120. The second, third, fourth, and fifth panels 124, 126, 128, 130 are collectively referred to as side panels.

The first part 100 further includes a third set of scored segments including a fifth, sixth, seventh, and eighth scored segment that are at an angle of approximately 45 degrees to each of the first set and second set of scored segments 114, 116, 118, 120. Specifically, the fifth segment 132 extends from point A to point E, thus forming a first triangular panel 134 bound by the first edge 106, the third segment 118, and the fifth segment 132 and a second triangular panel 136 bound by the third edge 110, the first segment 114, and the fifth segment 132. The sixth segment 138 extends from point B to point F, thus forming a third triangular panel 140 bound by the first edge 106, the fourth segment 120, and the sixth segment 138 and a fourth triangular panel 142 bound by the fourth edge 112, the first segment 114 and the sixth segment 138. The seventh segment 144 extends from point C to point G, thus forming a fifth triangular panel 146 bound by the second edge 108, the third segment 118, and the seventh segment 144 and a sixth triangular panel 148 bound by the third edge 110, the second segment 116, and the seventh segment 144. The eighth segment 150 extends from point D to point H, thus forming a seventh triangular panel 152 bound by the second edge 108, the fourth segment 120, and the eighth segment 150 and an eighth triangular panel 154 bound by the fourth edge 112, the second segment 116, and the eighth segment 150.

Referring to FIG. 2B, the second part 200 has a similar configuration as the first part 100 in that it includes a first (inside) surface 202, a second (outside) surface 204 (see FIG. 3D), and a plurality of edges comprised of a first edge 206, a second edge 208, a third edge 210, and a fourth edge 212. The first edge 206 and the second edge 208 are substantially parallel to each other. Similarly, the third edge 210 and the fourth edge 212 are substantially parallel to each other. In addition, the first and second edges 206, 208 are substantially perpendicular to the third and fourth edges 210, 212. The first edge 206 meets the third edge 210 at a point A′ and meets the fourth edge 212 at a point B′. Similarly, the second edge 208 meets the third edge 210 at a point C′ and meets the fourth edge 212 at a point D′.

The second part 200 further includes a plurality of scored segments including a first set of scored segments comprised of a first scored segment 214 and a second scored segment 216 and a second set of scored segments comprised of a third scored segment 218 and a fourth scored segment 220. The first set of scored segments 214, 216 are substantially perpendicular with the second set of scored segments 218, 220.

The first segment 214 is disposed a distance Y′ from the first edge 206, extends from the third edge 210 to the fourth edge 212 and is substantially parallel to the first and second edges 206, 208. The second segment 216 is disposed approximately the same distance Y′ from the second edge 208, extends from the third edge 210 to the fourth edge 212 and is also substantially parallel to the first and second edges 206, 208. Thus, both the first and second segments 214, 216 are substantially parallel to each other.

The third segment 218 is disposed a distance X′ from the third edge 210, extends from the first edge 206 to the second edge 208, and is substantially parallel to the third and fourth edges 210, 212. The fourth segment 220 is disposed approximately the same distance X′ from the fourth edge 212, extends from the first edge 206 to the second edge 208, and is also substantially parallel to the third and fourth edges 210, 212. Thus, both the third and fourth segments 218, 220 are substantially parallel to each other.

The first segment 214 intersects the third segment 218 at a point E′ and intersects the fourth segment 220 at a point F′. Similarly, the second segment 216 intersects the third segment 218 at a point G′ and intersects the fourth segment 220 at a point H′. Thus, a plurality of rectangular panels are defined by the intersection of the plurality of segments and the intersection of the plurality of segments with the plurality of edges.

Specifically, a first panel 222 is formed at a center of the first part 200 and is bound by the first, second, third and fourth segments 214, 216, 218, 220. A second panel 224 is bound by the first edge 206 and the first, third, and fourth segments 214, 218, 220. A third panel 226 is bound by the second edge 208 and the second, third, and fourth segments 216, 218, 220. A fourth panel 228 is bound by the third edge 210 and the first, second, and third segments 214, 216, 218. A fifth panel 230 is bound by the fourth edge 212 and the first, second, and fourth segments 214, 216, 220. The second, third, fourth, and fifth panels 224, 226, 228, 230 are collectively referred to as side panels.

The first part 200 further includes a third set of scored segments including the fifth 232, sixth 238, seventh 244, and eighth 250 scored segment that are at an angle of approximately 45 degrees to each of the first set and second set of scored segments 214, 216, 218, 220. Specifically, the fifth segment 232 extends from point A′ to point E′, thus forming a first triangular panel 234 bound by the first edge 206, the third segment 218, and the fifth segment 232 and a second triangular panel 236 bound by the third edge 210, the first segment 214, and the fifth segment 232. The sixth segment 238 extends from point B′ to point F′, thus forming a third triangular panel 240 bound by the first edge 206, the fourth segment 220, and the sixth segment 238 and a fourth triangular panel 242 bound by the fourth edge 212, the first segment 214 and the sixth segment 238. The seventh segment 244 extends from point C′ to point G′, thus forming a fifth triangular panel 246 bound by the second edge 208, the third segment 218, and the seventh segment 244 and a sixth triangular panel 248 bound by the third edge 210, the second segment 216, and the seventh segment 244. The eighth segment 250 extends from point D′ to point H′, thus forming a seventh triangular panel 252 bound by the second edge 208, the fourth segment 220, and the eighth segment 250 and an eighth triangular panel 254 bound by the fourth edge 212, the second segment 216, and the eighth segment 250.

Referring to FIG. 2C, the first part 100 and the second part 200 are sized slightly different such that the first part 100 can mate with the second part 200 to house an object, as will be described further below. Specifically, the sizing of the first and second part 100, 200 is such that the second part 200 can be placed over the first part 100 and serves to cover the first part 100 and hence, the object inside the first part 100. In an alternative embodiment, the second part 200 can be placed inside the second part 200. Thus, the first and second parts 100, 200 form the packaging container 20. Thus, X is not equal to X′ and Y is not equal to Y′. In other words, X may be larger or smaller than X′ and Y may be larger or smaller than Y′.

Referring to FIGS. 3A-3D, the packaging system 10 may further include one or more edge stiffeners 300 in accordance with an aspect of the innovation. The edge stiffener 300 is a U-shaped apparatus made from a flexible but rigid material that extends along any one of the edges described above. The edge stiffener 300 provides additional support to the first and/or second part 100, 200 and may further function to keep the first and/or second part 100, 200 in an assembled position. In addition, the edge stiffener 300 eliminates the use of staples, tape, adhesive, etc. to keep the first and/or the second part assembled. Still further, the edge stiffener can be removed and the first and/or second part 100, 200 can be unfolded to a flat state and stored for future use. Thus, the packaging system 10 is re-useable thereby reducing waste.

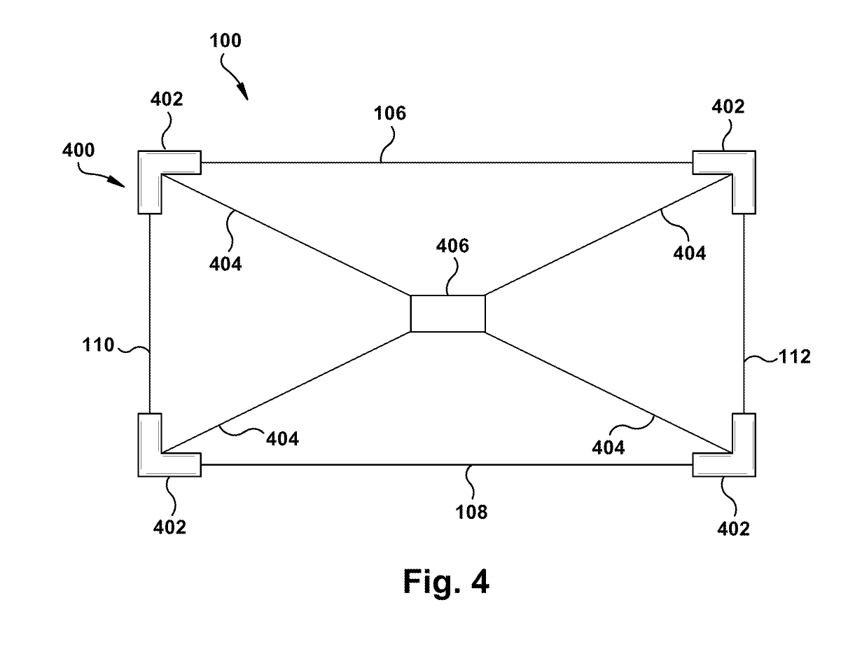

Referring to FIG. 4, the packaging system 10 may further include a support assembly 400 in accordance with an aspect of the innovation. The support assembly 400 may include one or more corner stiffeners 402 attached to one or more corners on the first and/or second part 100, 200. One or more connecting lines 404 may be included to that connect one or more corners stiffeners 402 to a center support 406. The center support 406 may have a height that is approximately the same as a height of a space defined between the first and second parts 100, 200 or between the object and the second part 200 inside the assembled packaging container 20 to provide support to the center of the packaging container 20.

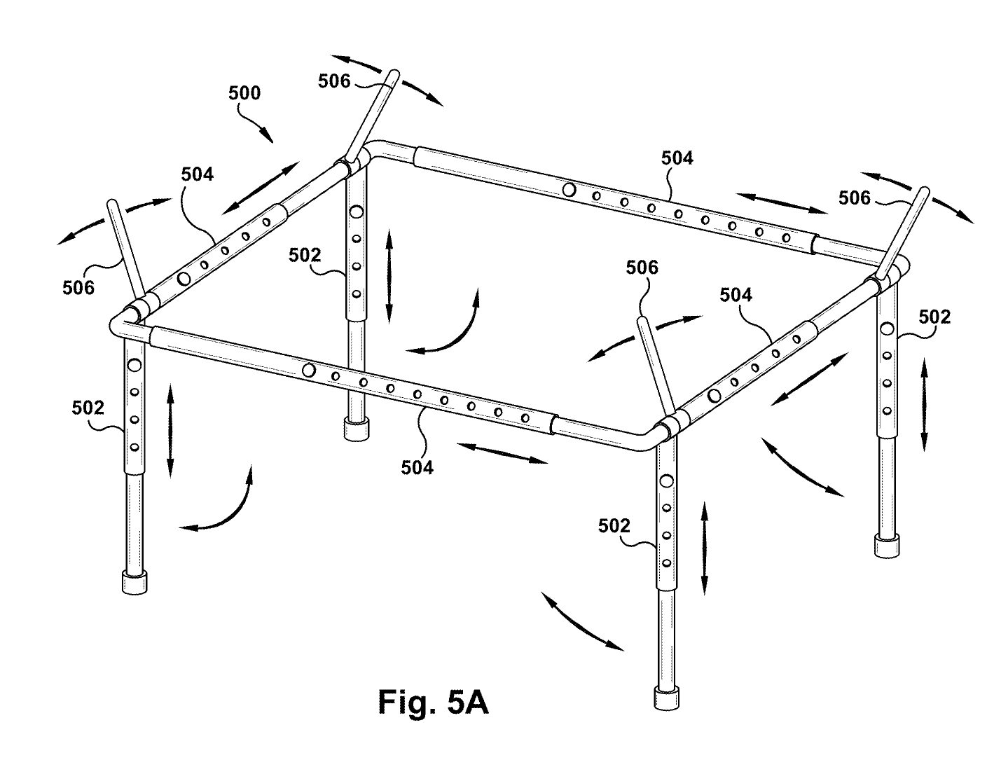

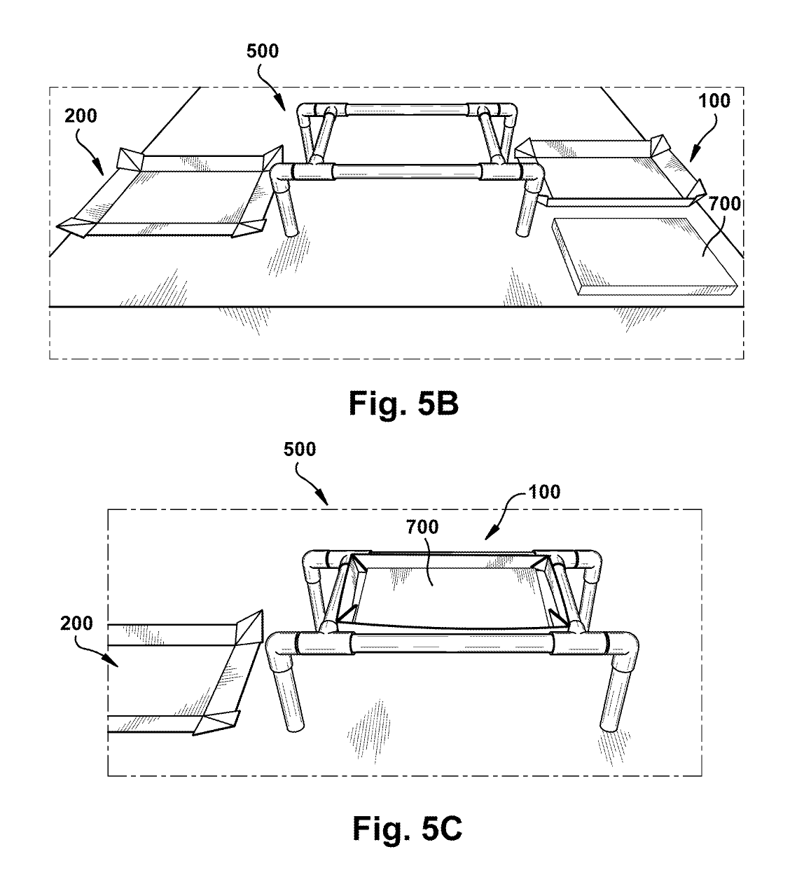

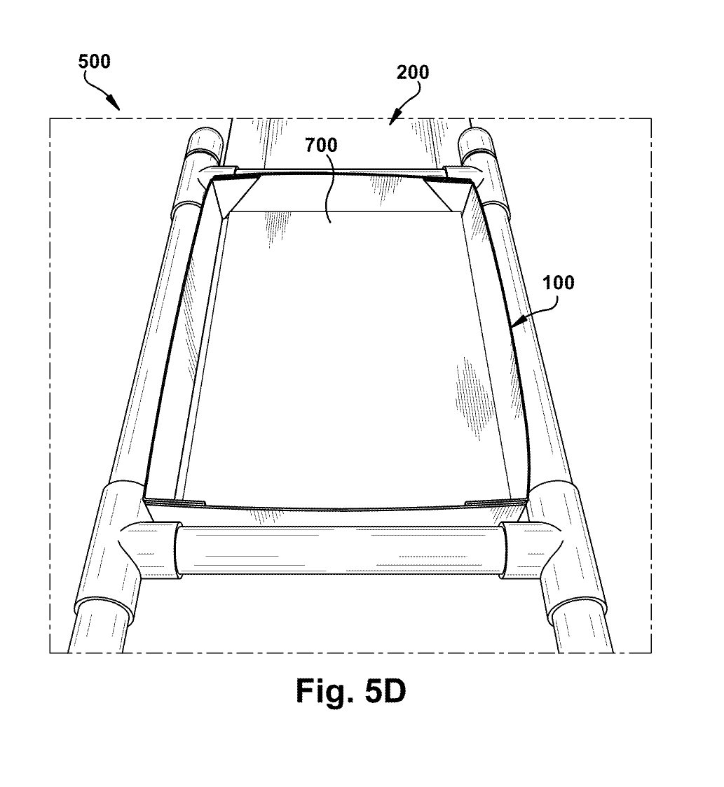

Referring to FIGS. 5A-5D, the packaging system 10 may further include an assembly assist fixture 500 in accordance with an aspect of the innovation. The fixture 500 may include telescoping legs 502 and/or telescoping side rails 504 such that the height, width, and length can be adjusted to accommodate any size packaging assembly (e.g., carton cardboard box, etc.). In addition, the legs 502 may be foldable for transport and/or storage purposes. The assist device 500 may further include rotatable/foldable arms 506 that rotate or pivot in any direction to assist in the assembly of the packaging container 20.

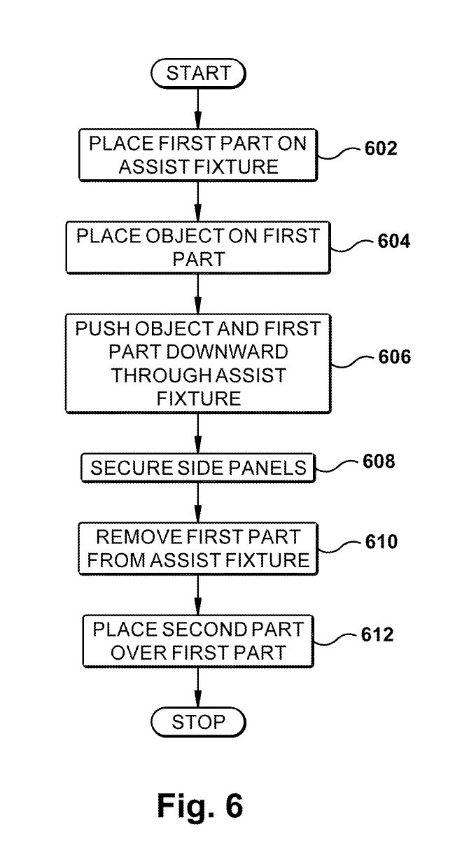

Referring to FIG. 6, a method of packaging an object using the innovative packaging system 10 disclosed herein will now be described. A first part or bottom carton 100 is provided having the features as defined herein. At 602, the first part 100 is placed onto the assist fixture 500. At 604, an object 700 is placed on the first part such that the object does not exceed the bounds defined by the first panel 122 defined above. At 606, the object and, hence the first part 100 are pushed downward through the side rails 504 of the assist device 500 such that the side panels and the triangular panels described above extend upwards and surround the first panel 122, as shown in FIGS. 5C and 5D. At 608, the side panels are secured in place with either the edge stiffeners 300, the corner stiffeners, or a securing mechanism, such as but not limited to, tape, an adhesive, etc. At 610, the first part is removed from the assist device 500. And at 612, the second part is placed over the first part 100 thereby enclosing the object and forming the assembled packaging container.

Advantages to the packaging system disclosed herein is that the packaging container can be assembled as the object is being packed. Thus, there is no need to pre-assemble the packaging container. As mentioned above, the packaging system is re-useable, thereby reducing costs and waste. As shown in FIG. 3C, the triangular panels provide a triple layer of material to the ends of the container thereby increasing the stiffness and protection to the object inside the container. Still further, the triangular panels are typically waste, thus, utilizing the triangular panels reduces waste material.

It is to be understood, that the first and/or second parts 100, 20 can be folded and assembled with or without the use of the assembly assist fixture 500. It is also to be understood that the configuration of the first and second parts 100, 200 and the associated segments and panels can have any configuration necessary to facilitate the packaging of any shape object. Thus, the example embodiment disclosed herein and illustrated in the figures is for illustrative purposes only and is not intended to limit the scope of the innovation.

It is to be understood, that the system and method disclosed herein is not limited to the type of material (e.g., cardboard box, carton, plastic container, etc.) used as the packaging container. In other embodiments, other materials, such as but not limited fabrics (e.g., nylon, polyester, ballistic nylon, canvas materials such as cotton, waterproof materials, etc.). Thus, because the system disclosed herein requires only a single piece, a seamless watertight container can be formed for applications that require watertight containers.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A packaging system comprising:
a first part having a plurality of scored segments and a plurality of panels formed by the plurality of scored segments; and
a second part having a plurality of scored segments and a plurality of panels formed by the plurality of scored segments, the second part being adapted to cover the first part;
wherein the first part is foldable along the plurality of scored segments; and
wherein the second part is foldable along the plurality of scored segments.

2. The packaging system of claim 1 further comprising at least one edge stiffener adapted to be placed on an edge of the first and/or second part.

3. The packaging system of claim 1 further comprising a support system including a plurality of corner stiffeners adapted to be placed on a corner of the first and/or second part.

4. The packaging system of claim 3, wherein the support system further includes a center support and a plurality of connecting lines that connect the corner stiffeners to the center support.

5. The packaging system of claim 1 further comprising an assembly assist fixture adapted to facilitate the assembly of the first and/or second part.

6. The packaging system of claim 5, wherein the assembly assist device includes telescoping legs and telescoping side rails adapted to adjust to facilitate the assembly of the first and/or the second having of various sizes.

7. The packaging system of claim 1, wherein the plurality of panels include a first panel disposed at a center of the first part, a plurality side panels surrounding the first panel and a plurality of triangular panels.

8. A method of assembling a packaging container comprising:
providing a first part and a second part, wherein the first part and the second part include a plurality of scored segments and a plurality of panels formed by the plurality of scored segments;
placing the first part onto an assembly assist fixture;
placing an object on the first part such that the object does not exceed a boundary of a first panel defined by the plurality of scored segments;
pushing the object downward such that side rails on the assembly assist fixture force the plurality of panels on the first part upward thereby surrounding the first panel;
removing the first part from the assembly assist fixture; and
placing the second part over the first part thereby enclosing the object inside the first part and the second part.

9. The method of claim 8 further comprising placing edge stiffeners on opposite edges of the first part.

10. The method of claim 8, wherein placing the second part over the first part thereby enclosing the object inside the first part and the second part includes folding the second part along the plurality of scored segments.

11. The method of claim 8 further comprising placing corner stiffeners on each corner of the first and/or second part.

12. The method of claim 11 further comprising adding a center support and a plurality of connecting lines that connect the corner stiffeners to the center support.

13. A container comprising:
a first part including:
a first set of scored segments;
a second set of scored segments substantially perpendicular to the first set of scored segments;
a third set of scored segments disposed at an angle with respect to the first set of scored segments and the second set of scored segments;
a plurality of panels formed by boundaries of the first set, the second set, and the third set of scored segments,
wherein the first part is foldable along the first set, the second set, and the third set of scored segments.

14. The container of claim 13 further comprising:
a second part including:
a first set of scored segments;
a second set of scored segments substantially perpendicular to the first set of scored segments;
a third set of scored segments disposed at an angle with respect to the first set of scored segments and the second set of scored segments;
a plurality of panels formed by boundaries of the first set, the second set, and the third set of scored segments,
wherein the second part is foldable along the first set, the second set, and the third set of scored segments.

15. The container of claim 14, wherein the angle of the third set of scored segments with respect to the first set of scored segments and the second set of scored segments of the first part is approximately 45 degrees.

16. The container of claim 15, wherein the angle of the third set of scored segments with respect to the first set of scored segments and the second set of scored segments of the first part is approximately 45 degrees.

17. The container of claim 14 further comprising at least one edge stiffener adapted to be placed on an edge of the first and/or second part.

18. The container of claim 17 further comprising a support system including a plurality of corner stiffeners adapted to be placed on a corner of the first and/or second part.

19. The container of claim 18, wherein the support system further includes a center support and a plurality of connecting lines that connect the corner stiffeners to the center support.

20. The container of claim 14, wherein the second part is larger than the first part such that the first part fits inside the second part to form the container.
